(19) United States
(12) Patent Application Publication
(10) Pub. No.: US 2025/0234374 A1
(43) Pub. Date: Jul. 17, 2025

(54) SYSTEMS AND METHODS OF STATION INITIATED TRANSMIT OPPORTUNITY SHARING

(71) Applicant: Meta Platforms Technologies, LLC, Menlo Park, CA (US)

(72) Inventors: Muhammad Kumail Haider, Sunnyvale, CA (US); Guoqing Li, Cupertino, CA (US)

(73) Assignee: Meta Platforms Technologies, LLC, Menlo Park, CA (US)

(21) Appl. No.: 18/977,677

(22) Filed: Dec. 11, 2024

Related U.S. Application Data
(60) Provisional application No. 63/620,008, filed on Jan. 11, 2024.

(51) Int. Cl. H04W 74/08; H04W 84/12

(52) U.S. Cl. CPC H04W 74/08; H04W 84/12

(57) ABSTRACT

A first wireless communication device may include one or more processors. The one or more processors may be configured to generate a first frame indicating to a wireless communication node that the first wireless communication device is to share a transmission opportunity (TXOP) with the wireless communication node to deliver traffic to the first wireless communication device or a second wireless communication device. Each of the first wireless communication device and the second wireless communication device may not be a wireless communication node. The one or more processors may be configured to wirelessly transmit, via a transmitter, the generated first frame to the wireless communication node in a wireless local area network (WLAN).

### CROSS-REFERENCE TO RELATED APPLICATION

This application claims priority to U.S. Provisional Patent Application No. 63/620,008 filed on Jan. 11, 2024, which is incorporated by reference herein in its entirety for all purposes.

### FIELD OF DISCLOSURE

The present disclosure is generally related to wireless communication between devices, including but not limited to, systems and methods for transmission opportunity sharing.

### BACKGROUND

Augmented reality (AR), virtual reality (VR), and mixed reality (MR) are becoming more prevalent, which such technology being supported across a wider variety of platforms and devices. Some AR/VR/MR devices may communicate with other devices within an environment, where such communication is provided via a channel or link between the devices. As part of establishing the connection, the devices may identify availability of the channel or link.

### SUMMARY

Various embodiments disclosed herein relate to a first wireless communication device including one or more processors. In some embodiments, the one or more processors may be configured to generate a first frame indicating to a wireless communication node that the first wireless communication device is to share a transmission opportunity (TXOP) with the wireless communication node to deliver traffic to the first wireless communication device or a second wireless communication device. Each of the first wireless communication device and the second wireless communication device may not be a wireless communication node. The one or more processors may configured to wirelessly transmit, via a transmitter, the generated first frame to the wireless communication node in a wireless local area network (WLAN).

In some embodiments, the first wireless communication device and the second wireless communication device may be associated with the wireless communication node. In some examples, the first wireless communication device may be paired or tethered to the second wireless communication device.

In some embodiments, the first frame may include a first field set to a value indicating that the first wireless communication device is to share the TXOP with the wireless communication node to deliver traffic to the first wireless communication device or the second wireless communication device. In some examples, the first frame may include and at least one of an association ID field, an address field, or quality of service (QOS) information element (IE). The association ID field may be set to an association ID of the second wireless communication device. Likewise, the address field may be set to an address of the second wireless communication device. The QOS IE may be set to a set of QoS parameters of a traffic stream between the wireless communication node and the second wireless communication device.

In some embodiments, the first frame may be an action frame including a category field set to a value indicating that the first wireless communication device and the second wireless communication device are paired. In some examples, the action frame may include a first field set to a value indicating that the first wireless communication device is to share the TXOP with the wireless communication node to deliver traffic to the first wireless communication device or the second wireless communication device. In some examples, the action frame may include a second field set to a value indicating whether the first wireless communication device allows QoS configuration of the second wireless communication device. In some examples, the action frame may include at least one of an association ID field or an address field, the association ID field set to an association ID of the second wireless communication device, the address field set to an address of the second wireless communication device.

In some embodiments, the first frame may include a capabilities information element (IE) relating to capabilities of the first wireless communication device. In some examples, the capabilities IE may include a first field set to a value indicating that the first wireless communication device is to share the TXOP with the wireless communication node to deliver traffic to the first wireless communication device or the second wireless communication device. In some examples, the capabilities IE may include a second field set to a value indicating whether a QoS information element (IE) is supported.

In some embodiments, the first frame may include a control field associated with a control ID indicating that the first wireless communication device is to share the TXOP with the wireless communication node to deliver traffic to the first wireless communication device or the second wireless communication device. In some examples, the control field may include a duration field set to a value indicating a remaining duration of the TXOP shared with the wireless communication node. In some examples, the control field may include a first field set to a value indicating whether the wireless communication node uses the shared TXOP to serve downlink data to the first wireless communication device. In some examples, the control field may include a second field set to a value indicating whether the wireless communication node uses the shared TXOP to serve downlink data to the second wireless communication device.

In some embodiments, the first frame may be a control frame. In some examples, the control frame may include a subtype field set to a value indicating that the first wireless communication device is to share the TXOP with the wireless communication node to deliver traffic to the first wireless communication device or the second wireless communication device. In some examples, the control frame may include a duration field set to a value indicating a remaining duration of the TXOP shared with the wireless communication node. In some examples, the control frame may include a first field set to a value indicating whether the wireless communication node uses the shared TXOP to serve downlink data to the first wireless communication device. In some examples, the control frame may include a second field set to a value indicating whether the wireless communication node uses the shared TXOP to serve downlink data to the second wireless communication device, In an example, the control frame may be one of an association response, a reassociation response, a probe response, or an action frame.

In some embodiments, the first frame may be a trigger frame. In some examples, the trigger frame may include a triggered TXOP sharing mode field set to a value indicating that the first wireless communication device is to share the TXOP with the wireless communication node to deliver traffic to the first wireless communication device or the second wireless communication device. In some examples, the trigger frame may include an association ID field set to an association ID of the second wireless communication device. In an examples, the trigger frame may be a multiuser (MU) request-to-send (RTS) TXOP sharing (TXS) trigger frame.

Various embodiments disclosed herein are related to a method, including generating, by one or more processors of a first wireless communication device, a first frame indicating to a wireless communication node that the first wireless communication device is to share a transmission opportunity (TXOP) with the wireless communication node to deliver traffic to the first wireless communication device or a second wireless communication device. Each of the first wireless communication device and the second wireless communication device may not be a wireless communication node. The method nay include wirelessly transmitting, by the one or more processors via a transmitter, the generated first frame to the wireless communication node in a wireless local area network (WLAN).

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system in which a TXOP can be shared, according to an example implementation of the present disclosure.

FIG. 6 is a sequence diagram showing communications between different devices, according to an example implementation of the present disclosure.

FIG. 7 is a diagram showing an example field to indicate a peer device for TXOP sharing, according to an example implementation of the present disclosure.

FIG. 8 is a diagram showing an example field to indicate capabilities for TXOP sharing, according to an example implementation of the present disclosure.

FIG. 9 is a diagram showing an example field to initiate TXOP sharing, according to an example implementation of the present disclosure.

FIG. 10 is a diagram showing another example field to initiate TXOP sharing, according to an example implementation of the present disclosure.

FIG. 11 is a diagram showing yet another example field to initiate TXOP sharing, according to an example implementation of the present disclosure.

FIG. 12 is a flowchart showing an example method of TXOP sharing, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

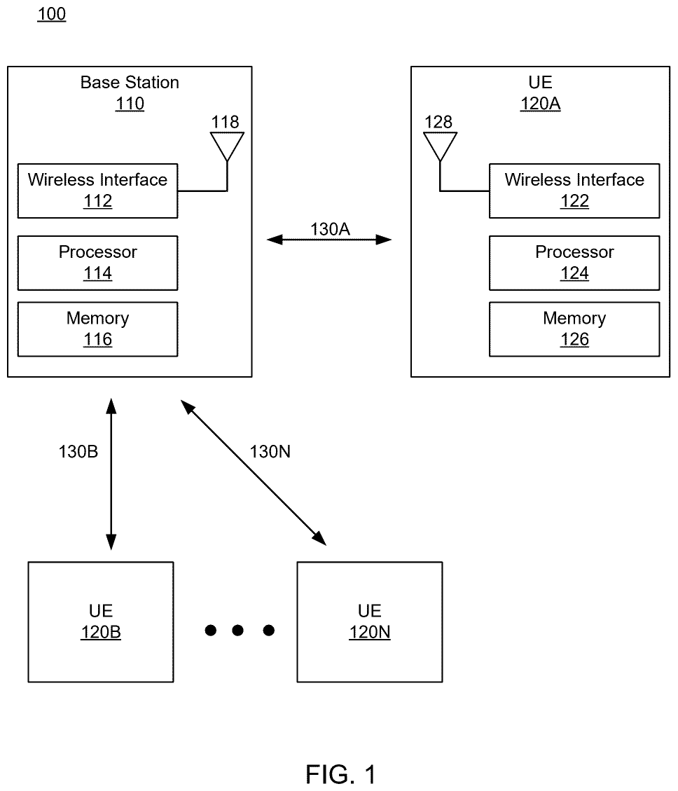

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

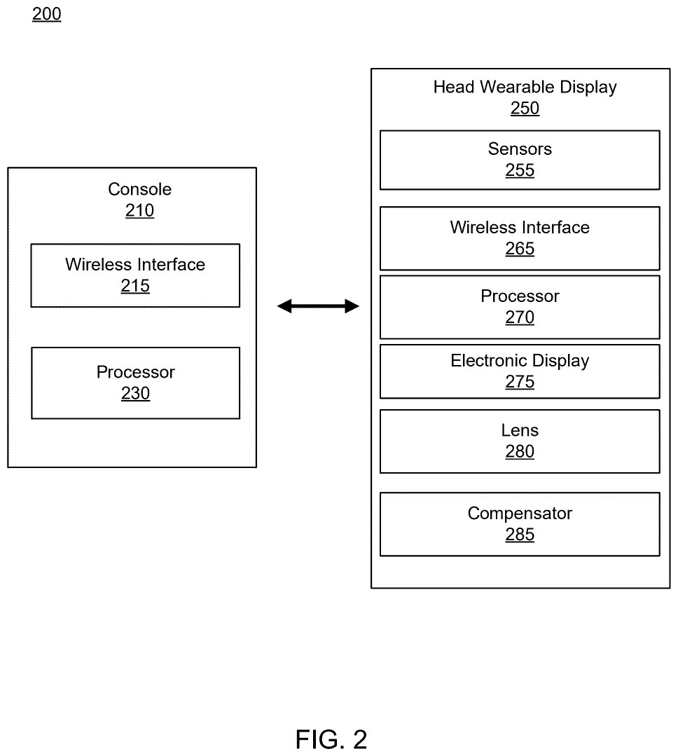

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

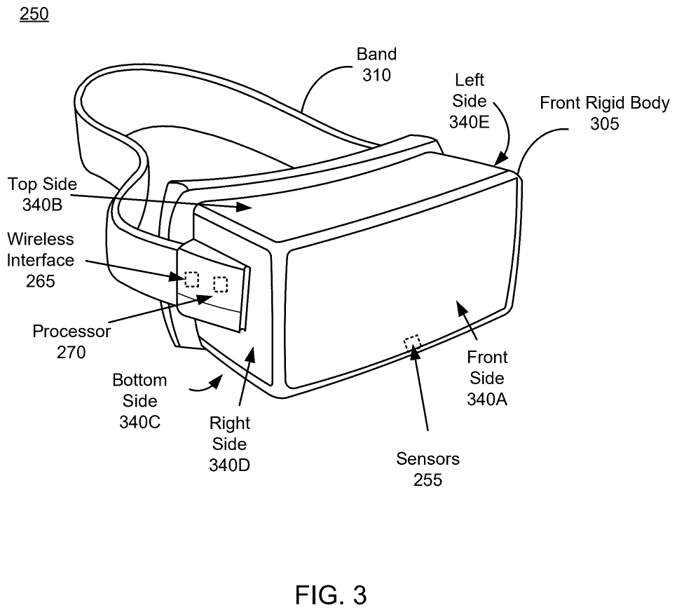

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

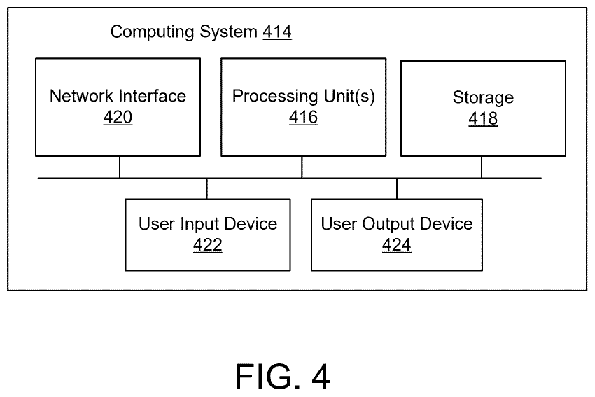

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Disclosed herein are related systems and methods for transmission opportunity (TXOP) sharing. As part of transmitting and receiving data, a first device may initiate TXOP sharing to share a TXOP with the communication node. The shared portion of the TXOP may be used to transmit downlink data to the first device or a second device from the communication node. According to the systems and methods described herein, a first device may transmit a frame indicating that the TXOP is to be shared.

Some TXOP sharing methods may allow an access point (AP) to share a part of a TXOP that it has obtained with an associated STA (e.g., a non-AP STA). In various examples, the STA may utilize the allocated part of the TXOP to transmit data to the AP and/or a peer STA. For extended reality (XR) use cases, several devices (e.g., non-AP STAs) may connect to an AP. For example, an XR headset, XR controller, and/or laptop may connect to the AP. In this example, two or more of the devices may be peer devices that are paired with one another. It may be beneficial for a non-AP STA to share a part of a TXOP that the non-AP STA has acquired with the AP. This may allow the AP to transmit data back to the non-AP STA or to the peer non-AP STA using the remaining portion of the TXOP. By virtue of the systems and methods disclosed herein, the non-AP STA may facilitate more efficient use of a medium. The AP may transmit data during an unused portion of a TXOP acquired by the non-AP STA, reducing contention for transmission and wait time for access to the medium.

Systems and methods according to some implementations can provide a TXOP sharing solution for the non-AP STA to generate a frame that indicates to the AP that a TXOP acquired by the non-AP STA is to be shared. The frame may indicate information about the remaining portion of the TXOP and/or which device the AP may transmit data to using this remaining portion. Based on receiving the frame, the AP may transmit downlink data to either the non-AP STA or the peer non-AP STA based on information included in the frame.

According to the systems and methods described herein, a first wireless device may be paired with a second wireless device. The first wireless device may generate a first frame indicating to a wireless communication node that the first wireless device is to share a TXOP with the wireless communication node. The first frame may include information about the remaining portion of the TXOP (e.g., a portion of the TXOP other than a portion shared with the wireless communication node), information identifying the second wireless device as a peer device, and/or information about which device the wireless communication node should transmit data to using the remaining portion of the TXOP. The first wireless device may transmit the first frame to the wireless communication node in a wireless local area network (WLAN).

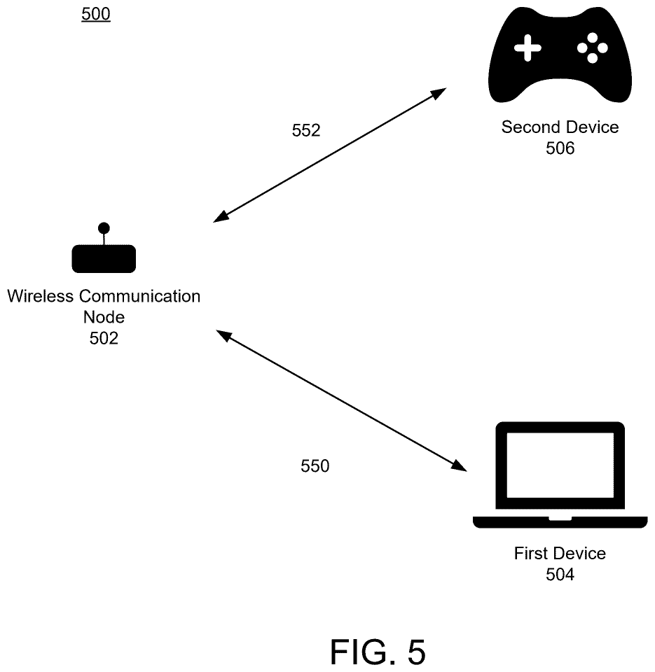

Referring now to FIG. 5, depicted is a block diagram of a system 500 in which a TXOP can be shared, according to an example implementation of the present disclosure. The system may include a wireless communication node 502, first device 504, and second device 506. The first device 504 and the second device 506 may be similar to the devices, components, elements, or hardware described above with reference to FIG. 1-FIG. 4. For example, the first device 504 and the second device 506 may be similar to the UEs 120, console 210, head wearable display 250, or any other form of user equipment. Additionally or alternatively, the wireless communication node 502 may be the same or similar to the base station 110. The first device 504, the second device 506, and the wireless communication node 502 may include components, elements, hardware, etc. similar to the devices described above, such as processor(s) 124, memory 126, etc. The wireless communication node 502, first device 504, and second device 506 may include hardware to support various wireless communication technology or technologies. For example, they may be configured to wireless local area network (WLAN) communication via one or more WLAN antennas or transceivers (e.g., WI-FI transceiver).

The components may communicate by communication link 550 and communication link 552. The first device 504 may transmit uplink data to the wireless communication node 502 via the communication link 552, and the wireless communication node 502 may transmit downlink data to the first device 504 via the communication link 550. Similarly, the second device 506 may transmit uplink data to the wireless communication node 502 via the communication link 552 and the wireless communication node 502 may transmit downlink data to the second device 506 via the communication link 552. In some examples, the communication link 550 and the communication link 552 may be wireless communication links. Examples of wireless links can include a cellular communication link, a near field communication link, Wi-Fi, Bluetooth, or any communication wireless communication link. In some examples, the first device 504 may transmit data to the second device 506 (or the second device 506 to the first device 504) via the wireless communication node 502. For example, the first device 504 may transmit data to the wireless communication node 502 via the communication link 550. In this example, the wireless communication node 502 may transmit the received data to the second device 506 via the communication link 552 based on receiving the data from the first device 504.

The wireless communication node 502 may be an access point (AP). As an AP, the wireless communication node 502 may create a wireless local area network (WLAN) that devices may connect to. In some examples, the wireless communication node 502 may manage traffic in this WLAN. By connecting to the wireless communication node 502, the first device 504 and the second device 506 may access resources, such as the internet, and/or communicate with each other.

The first device 504 may be a non-AP STA. As an example, the first device 504 may be a laptop. Similarly, the second device 506 may be a non-AP STA. As an example, the second device 506 may be a VR head set. As another example, the second device 506 may be a controller. In an example, the second device 506 may be paired (e.g., tethered) to the first device 504. In some examples, the first device 504 and the second device 506 may be used to play a video game. In these examples, video game data (e.g., graphics data, pose data, and/or the like) may be transmitted between the first device 504 and the second device 506. In an example wherein the second device 506 is a VR headset, the first device 504 may transmit graphics data to the second device 506. In this example, the VR headset may display the graphics data based on receiving it. In an example wherein the second device 506 is a controller, the second device 506 may transmit pose data (e.g., as recognized from a sensor in the second device 506) to the first device 504. In this example, the first device may adjust game parameters (e.g., change the position of an avatar, assign points, and/or the like) based on receiving the position data. In some examples, the first device 504 may be paired with multiple peer devices. As an example, the first device 504 may be paired with both a VR headset and a controller.

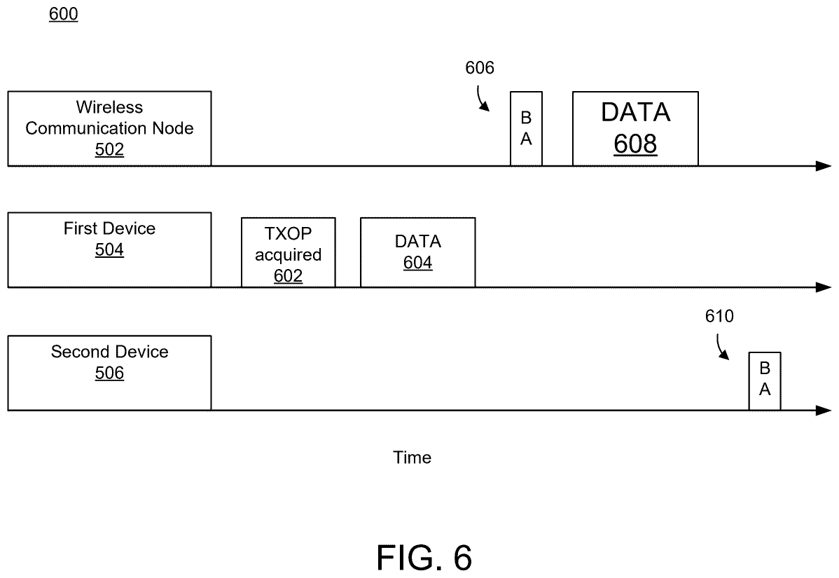

Referring now to FIG. 6, depicted is a sequence diagram 600 showing communications between different devices, according to an example implementation of the present disclosure. Through the exchange of data depicted in FIG. 6, the first device 504 may initiate sharing of a TXOP that it has acquired. By virtue of the system described herein, a device may initiate TXOP sharing with its associated AP or another device associated with the AP.

In some embodiments, the first device 504 may acquire a TXOP at (or for a duration of) TXOP acquired block 602. In order to acquire a TXOP, a device may or must contend for access to the medium. In some examples, the medium may be the material that data is communicated over (e.g., air) and signals at several frequencies (e.g., 2.4 GHz, 5 GHZ, and/or the like) may be transmitted over the medium. The first device 504 may use a carrier sensing method to determine if there are any ongoing transmissions over the medium. In this example, the first device may use a carrier sensing such as physical carrier sense (PCS) to monitor RF energy on the medium and/or virtual carrier sense (VCS) to track reserved periods on the medium. In response to determining that the medium is idle, the first device 504 may wait for a backoff time before transmitting data. In this example, multiple devices transmitting data on the medium may each randomly generate a period of time for the backoff time. The device whose backoff time period runs out first wins the TXOP and may begin transmitting. In the illustrated example in FIG. 6, the first device may win the TXOP based on determining that the medium is idle and waiting for a backoff period.

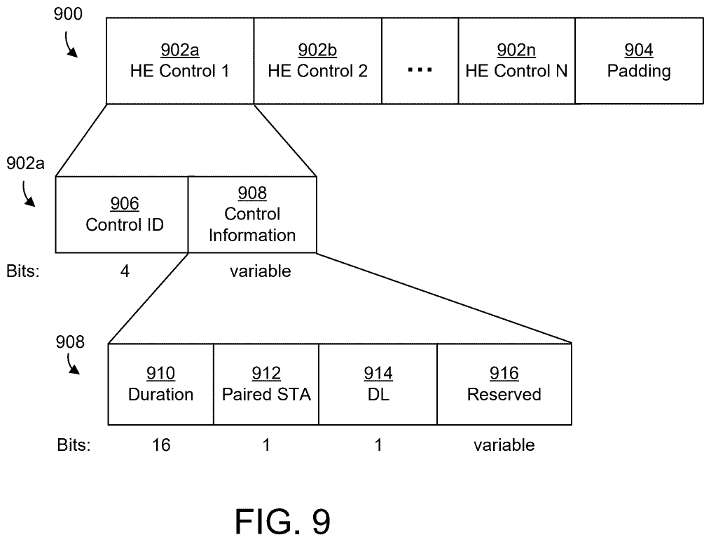

Based on winning the TXOP, the first device may transmit data 604 to the wireless communication node 502. For example, the first device may transmit frames of data to the wireless communication node 502 via the medium. As an example, the data 604 may contain graphics data transmitted from the first device. In an example wherein the second device 506 is a VR headset (e.g., head wearable display 250 of FIG. 2), the wireless communication node may transmit the graphics data to the second device 506 based on the graphics data received from the first data. In some examples, the data 604 may include a TXOP sharing field. In this example, the first device 504 may initiate TXOP sharing by including this field in the data 604. The TXOP sharing field may be the same or similar to control information field 908 of FIG. 9. In some examples, the wireless communication node 502 may use a portion of the TXOP to transmit downlink data to the first device 504 in response to receiving a frame with the TXOP sharing field. For example, the field may indicate a duration (e.g., duration field 910 of FIG. 9). Additionally or alternatively, the TXOP sharing field may include a field indicating the wireless communication node 502 should send data to the second device 506 (e.g., paired STA 912 of FIG. 9) and/or a field indicating the wireless communication node 502 should send downlink data to the same device (e.g., downlink (DL) field 914 of FIG. 9).

The wireless communication node 502 may send an acknowledgement 606 to the first device 504 in response to receiving the data 604 from the first device 504. In some examples, the acknowledgement block 606 may be an ACK frame. Alternatively, the communication node may transmit a block acknowledgement (BA) frame in response to receiving the data 604. In this example, the BA frame may provide information on which frames were successfully transmitted, and which frames failed to transmit. The acknowledgement may communicate to the first device 504 that the data 604 has been successfully transmitted and does not need to be resent. For example, if the first frame does not receive an acknowledgement 606, the data 604 may be resent.

In embodiments wherein the data 604 does not include a TXOP sharing field, the first device 504 may transmit a control frame including a field (e.g., control information field 908 of FIG. 9) that initiates TXOP sharing to the wireless communication node 502. For example, the first device 504 may transmit a QoS NULL or QOS DATA frame with a TXOP sharing field. In this example, the TXOP Sharing field may indicate that the wireless communication node 502 may or should transmit data to the second device 506 with the remainder of the TXOP (e.g., a portion of the TXOP other than a portion shared with the wireless communication node 502).

In some embodiments, the wireless communication node 502 may transmit data 608 based on the received data 604. For example, the wireless communication node may transmit data 608 in response to receiving and acknowledging data 604. In some examples, the wireless communication node 502 may transmit data 608 to the second device 506. In this example, the first device 504 may transmit a frame to the wireless communication node 502 with instructions to use the remaining part of the TXOP to transmit data to the second device 506. Alternatively, the wireless communication node 502 may transmit data 608 to the first device 504. In this example, the first device 504 may transmit a frame to the wireless communication node 502 with instructions to use the remaining part of the TXOP to transmit data back to the first device 504. In some examples, the frame may indicate that the wireless communication node may transmit downlink data to either the first device 504 or the second device 506 with the remaining part of the TXOP. In this example, the wireless communication device may determine which device to transmit data to. In an example, this determination may be made based on data traffic conditions (e.g., which device has higher priority, has more data that needs to be transmitted, and/or the like).

In some embodiments, the device that receives the data 608 may send an acknowledgement 610 of the data. For example, the first device 504 may transmit an acknowledgement 610 to the wireless communication node 502 in response to (receiving) the data 608. Alternatively, the second device 506 may transmit an acknowledgement 610 to the wireless communication node 502 in response to (receiving) the data 608. As described above, the acknowledgement may be an ACK frame or a BA frame.

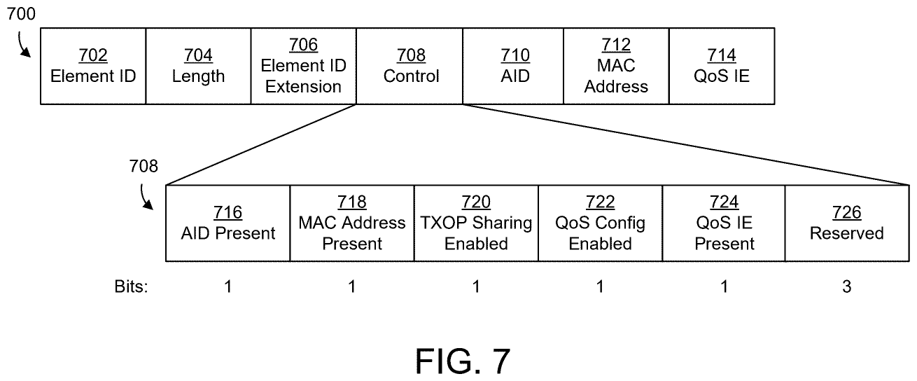

Referring now to FIG. 7, depicted is a diagram showing an example field to indicate a peer device for TXOP sharing, according to an example implementation of the present disclosure. The example field may identify information about a peer device that is to be designated for TXOP sharing. In some examples, the example field may be inserted into a management frame (e.g., (Re) Association Response, Probe Response) or an action frame to designate another device with which the TXOP is to be shared. For example, a first station (STA) (e.g., the first device 504 of FIG. 5) may send a frame with the paired STA indication element 700 inserted into it to designate a second STA (e.g., the second device 506 of FIG. 5) as a device for TXOP sharing. In this example, the frame with the paired STA indication element 700 may be transmitted to an access point (AP) (e.g., wireless communication node 502 of FIG. 5). Based on receiving the frame with the paired STA indication element 700, the AP may use a portion of a TXOP won by the first STA or the second STA to transmit downlink data to the first STA or the second STA. In some examples, the AP may initiate TXOP sharing based on receiving the frame with the paired STA indication element 700 from both the first STA and the second STA. In these examples, initiating TXOP sharing based on receiving the paired STA indication element from both STAs may be implemented to increase security. In some examples, the AP may perform QoS configuration of a peer STA based on receiving the frame with the paired STA indication element 700 from the first STA. The QoS configuration in these examples may determine which types of data are prioritized for transmission.

The paired STA indication element 700 may include the following fields: element ID 702 (1 octet), length 704 (1 octet), element ID extension 706 (1 octet), control 708 (1 octet), AID (association identity/identifier) 710 (0 or 2 octets) MAC address 712 (0 or 6 octets), and/or QoS IE 714 (variable number of octets). In some examples, the element ID field 702 may indicate the type of element. In this example, the element ID field 702 may include a value designating the paired STA indication element 700 as a paired STA indication element. In some examples, the element ID extension field 706 may provide further information on the element ID. For example, if the element ID designation is a number that is too large to be expressed by 1 octet, the element ID extension field 706 may provide room to express a larger number. In some examples, the length field 704 may indicate the length of the data that follows the length field 704 (e.g., fields 708-714). In some examples, the AID field 710 and/or the MAC address field 712, may designate the STA that is to be paired. In some examples, the QOS IE field 714 may indicate QoS-related information that a peer STA is to be configured with. For example, the first STA may send a paired STA indication element 700 that designates the second STA by its AID address at the AID field 710 and QoS-related information that the second STA is to be configured with at the QOS IE field 714.

The control field 708 may include the following subfields: AID present 716 (1 bit), MAC address present 718 (1 bit), TXOP sharing enabled 720 (1 bit), QoS config enabled 722 (1 bit), QOS IE present 724 (1 bit), and/or a reserved section 726 (3 bits). AID present subfield 716, MAC address present subfield 718, and QOS IE present subfield 724 may indicate whether there is an AID included at AID 710, a MAC address present at MAC address 712, and/or a QOS IE present at 714, respectively. For example, a value of 1 in the AID present field 716 may indicate that two octets of data identifying an AID are present at AID 710. TXOP sharing enabled subfield 720 and QoS config enabled subfield 722 may indicate whether the STA sending the paired STA indication element 700 wants to enable TXOP sharing and/or QoS configuration for the peer device, respectively. For example, the first STA may send the paired STA indication element 700 with a value of 1 for TXOP sharing enabled field sub720 to indicate that the first STA wants to enable TXOP sharing with the second STA. Likewise, a value of 1 for the QoS config enabled subfield 722 may indicate that the first STA wants to enable QoS configuration of the second STA.

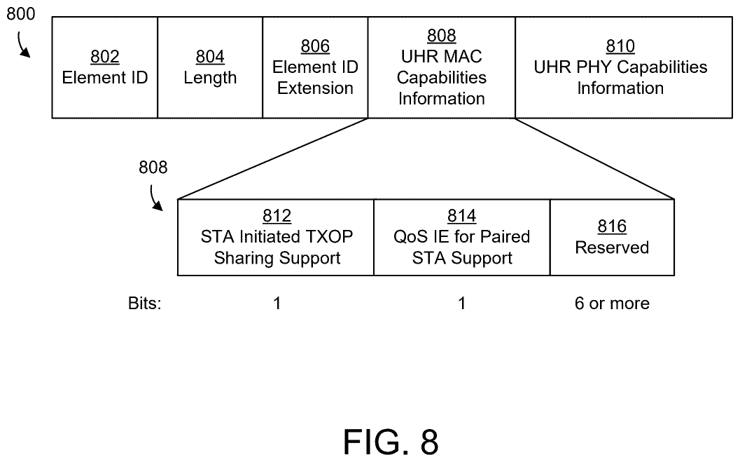

Referring now to FIG. 8, depicted is a diagram showing an example field to indicate capabilities for TXOP sharing, according to an example implementation of the present disclosure. This example field may include information about ultra-high reliability (UHR) capabilities that enable high data rates and low latency. The UHR capabilities may describe physical layer (PHY) capabilities (e.g., bandwidth, modulation, multi-stream capabilities, and/or the like) and MAC capabilities (e.g., multiple spatial streams, multi-link operation (MLO), and/or the like). In an example, details about TXOP sharing may be included with the UHR MAC capabilities information. The first STA may transmit a UHR capabilities element 800 to the AP to indicate that it has the capability for STA initiated TXOP sharing. Additionally or alternatively, the AP may indicate its STA initiated TXOP sharing capabilities to an STA, such as the first STA by transmitting the UHR capabilities element 800 to the STA.

The UHR capabilities element 800 may include the following fields: element ID 802 (1 octet), length 804 (1 octet), element ID extension 806 (1 octet), UHR MAC capabilities information 808 (1 or more octets), and/or UHR PHY capabilities information 810 (1 or more octets). The element ID 802 may be the same or similar to the element ID 702 of FIG. 7, the length 804 may be the same or similar to the length 704 of FIG. 7, and the element ID extension 806 may be the same or similar to the element ID extension 706 of FIG. 7.

The UHR MAC capabilities information field 808 may include the following subfields: STA Initiated TXOP sharing support 812 (1 bit), QOS IE for paired STA support 814 (1 bit), and/or reserved 816 (6 or more bits). In some examples, the STA initiated TXOP sharing support field may indicate whether the STA sending the UHR capabilities element 800 supports TXOP sharing. For example, the first STA may transmit a value of 1 in the STA initiated TXOP sharing support subfield 812 to indicate that the first STA does support TXOP sharing. In some examples, the QOS IE for paired STA support subfield 814 may indicate whether the STA sending the UHR capabilities element 800 can deliver QOS IE for traffic from an AP to another paired STA associated with the AP. For example, the first STA may transmit a value of 1 in this field to indicate that it can deliver QoS IE for traffic from the AP to another paired device, such as the second STA. In some examples, the STA initiated TXOP sharing support field and/or QoS IE for paired STA support field may include additional subfields and/or may be present in a different element.

Referring now to FIG. 9, depicted is a diagram showing an example field to initiate TXOP sharing, according to an example implementation of the present disclosure. In this example, a subfield of a control field is illustrated. A control frame with the control field, including the subfield, may be submitted by an STA to an AP to initiate TXOP sharing. For example, the first STA may submit the control field to the AP to initiate TXOP sharing with the AP and/or the second STA. In some examples, the control field may be a High Efficiency (HE) variant High Throughput (HT) control field, and the subfield may be an A-Control subfield. The A-control subfield 900 may include the fields of a plurality of HE controls 902 (including HE control 1 902a, HE control 2 902b, . . . , 902n) and a padding 904. Each HE control may define a distinct control (e.g., trigger response scheduling, buffer status report, and/or the like). In the illustrated example, HE control 1 902a may define TXOP sharing. Each HE control may include the fields of control ID 906 (e.g., with 4 bits) and control information 908 (e.g., with variable number of bits). The control ID may identify which control an HE control defines. Some control IDs may have standardized definitions (e.g., control ID 1 may identify the HE control as defining trigger response scheduling), while others may not. In an example, control IDs without standardized definitions may have functions that are unique to a device or set of devices. In some examples, the control ID field 906 may be set to control ID 10. In this example, control ID 10 may identify the control field as an STA initiated TXOP sharing control field within a set of devices (e.g., the first device 504, wireless communication node 502, and second device 506 of FIG. 5). In other examples, the control ID may be set to any other available value.

The control information field 908 may include the following subfields: duration 910 (16 bits), paired STA 912 (1 bit), DL 914 (1 bit), and/or reserved 916 (variable bits). The duration field 910 may define a duration of a TXOP that the STA sending the A-control subfield 900 is allocating. For example, the first STA may indicate a length of the TXOP it is sharing with the AP in the duration field 910. In other examples, the control information field 908 may include an AID subfield in addition to or in place of the duration field 910. In these examples, the AID field may indicate a paired STA that the AP should transmit DL data to. For example, the sending STA may be paired with more than one STA's. In this example, the AID may identify which paired STA the AP should transmit DL data to. In examples, that do not include a duration field 910, the duration information may be determined from another part of the frame containing the A-control subfield 900. For example, the allocated length of the TXOP that is being shared may be determined from the MAC header of the frame. The paired STA field 912 may indicate whether the AP receiving the A-control subfield 900 may use the allocated TXOP to transmit data to a paired STA. For example, the first STA may send a value of 1 (or other value) in the paired STA field 912 to the AP to indicate that the AP may transmit DL data to the second STA with the allocated TXOP. The DL field 914 may indicate whether the AP receiving the A-control subfield 900 may use the allocated TXOP to transmit data to the STA sending the A-control subfield 900. For example, the first STA may transmit a value of 1 (or other value) in the DL field 914 to indicate that the AP may transmit downlink data to the first STA using the allocated TXOP. In some examples, both the paired STA field 912 and the DL field 914 may include a value of 1. In this example, the AP may use multi-user technologies to transmit downlink data the STA that sends the A-control subfield 900 and the peer STA.

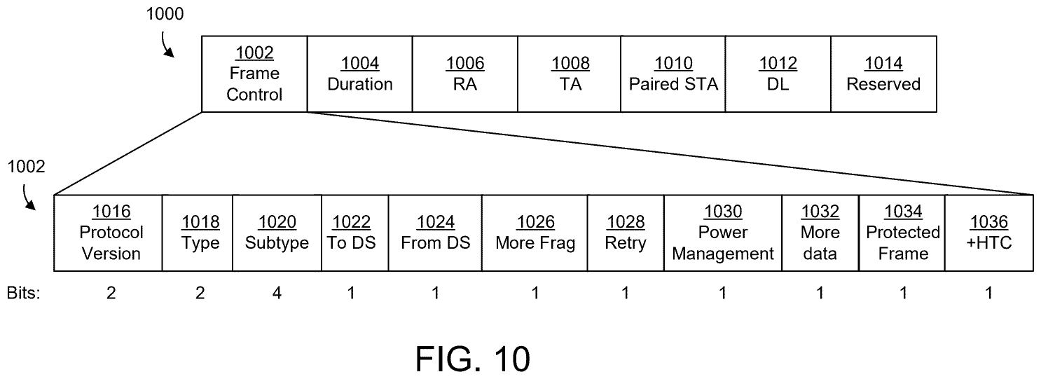

Referring now to FIG. 10, depicted is a diagram showing another example field to initiate TXOP sharing, according to an example implementation of the present disclosure. The control frame 1000 may be transmitted to an AP from an STA to initiate TXOP sharing. For example, the first STA may transmit the control frame 1000 to the AP to initiate TXOP sharing with the AP. In this example, the remaining portion of the TXOP may be utilized to transmit downlink data from the AP to the first STA or from the AP to another paired STA (e.g., the second STA). In some examples, the control frame 1000 may be a control frame that is carried in a non sub-1 GHZ physical protocol data unit.

The control frame 1000 may include the following fields: frame control 1002 (e.g., with 16 bits), duration 1004 (e.g., with 16 bits), received address (RA) 1006 (e.g., with 48 bits), transmitter address (TA) 1008 (e.g., with 48 bits), paired STA 1010 (e.g., with 1 bit), DL 1012 (e.g., with 1 bit), and/or reserved 1014 (e.g., with 6 bits). The duration field 1004 may be the same or similar to the duration field 910 of FIG. 9, the paired STA field may be the same or similar to the paired STA field 912 of FIG. 9, and the DL field 1012 may be the same or similar to the DL field 914 of FIG. 9. The received address and transmitter address included in the RA field 1006 and TA field 1008 may include predefined fields in the IEEE 802.11 standard. For example, the RA field 1006 may contain the address of the device that is intended to receive the frame. In an example wherein the first STA transmits the frame to the AP, the RA field 1006 may contain the address of the AP. Similarly, the TA field 1008 may contain the address of the device that transmits the frame. In an example wherein the first STA transmits the frame to the AP, the TA field 1008 may contain the address of the first STA. The frame control field 1002 may include information related to TXOP sharing.

The frame control field 1002 may include the following subfields: protocol version 1016 (e.g., with 2 bits), type 1018 (e.g., with 2 bits), subtype 1020 (e.g., with 4 bits), to distribution system (DS) 1022 (1 bit), from DS 1024 (e.g., with 1 bit), more frag 1026 (1 bit), retry 1028 (e.g., with 1 bit), power management 1030 (e.g., with 1 bit), more data 1032 (1 bit), protected frame 1034 (e.g., with 1 bit), and/or + high throughput control (HTC) 1036 (e.g., with 1 bit). In some examples, the subtype subfield 1020 may be assigned to a next available value to uniquely identify the frame as an STA initiated TXOP sharing frame. The protocol version subfield 1016 may indicate which protocol version the frame is running on (e.g., the IEEE 802.11 standard). The type subfield 1018 may identify the frame as a control frame. The to DS field 1022, from DS field 1024, more frag field 1026, retry field 1028, protected frame field 1034, and/or +HTC field 1036 may include a value of 0 to indicate that these features are not enabled. The power management field 1030 may indicate whether the transmitting device is in active mode or power save mode. The more data field 1032 may indicate whether the control frame 1000 is last or if there are more frames that are to be transmitted.

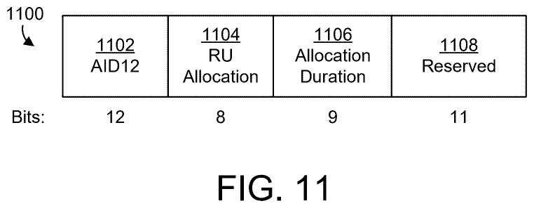

Referring now to FIG. 11, depicted is a diagram showing yet another example field to initiate TXOP sharing, according to an example implementation of the present disclosure. An STA may transmit a trigger frame with user info field 1100 to initiate TXOP sharing. In some examples, the trigger frame may be a multi-user (MU) request to send (RTS) trigger frame. The trigger frame may include a triggered TXOP sharing mode value, such as those shown in table 1. For example, the first STA may transmit a trigger frame with a triggered TXOP sharing mode subfield value of 3 to indicate that the first STA is allocating a remaining portion of a TXOP to the AP. The trigger frame may also include user info field 1100 as information about the allocation.

TABLE 1
Triggered TXOP Sharing Mode subfield encoding

| Triggered TXOP | |
|---|---|
| Sharing Mode | |
| Subfield value | Description |
| 0 | MU-RTS that does not initiate TXS procedure |
| 1 | MU-RTS that initiates TXS procedure wherein a |
| | scheduled STA can only transmit MPDU(s) addressed |
| | to its associated AP |
| 2 | MU-RTS that imitates TXS procedure wherein a |
| | scheduled STA can transmit MPDU(s) addressed to its |
| | associated AP or addressed to another STA |
| 3 | MU-RTS that initiates TXOP haring procedure |
| | wherein a non-AP STA can allocate remaining TXOP |
| | to the AP |

The user info field 1100 may contain the following subfields: AID12 1100 (e.g., with 12 bits), resource usage (RU) allocation 1104 (8 bits), allocation duration 1106 (e.g., with 9 bits), and/or reserved 1108 (e.g., with 11 bits). The AID12 field may identify a peer device with an AID that is 12 bits long. In an example wherein the first STA transmits the trigger frame to the STA, the AID12 field may identify the second STA. The RU allocation field 1104 may include details about how the resource (e.g., remaining portion of the TXOP) is being allocated. In some examples, the RU allocation field may contain information about use of the TXOP. For example, it may specify whether the AP is to use the allocated TXOP to transmit data to the transmitting STA or a peer STA. The allocation duration field 1106 may contain information about how long the portion of the TXOP is that is being allocated. In response to receiving the trigger frame from an STA, an AP may send a clear to send (CTS) frame. In some examples, the trigger frame may only include the AID12 field 1102 or may not include a user-info field.

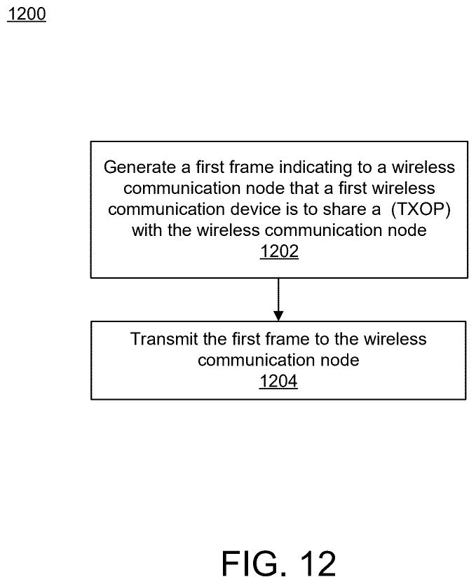

Referring now to FIG. 12, depicted is a flowchart showing an example method 1200 of TXOP sharing, according to an example implementation of the present disclosure. In some embodiments, the method may be performed by a non-AP STA. For example, the method may be performed by a first wireless communication device (e.g., first device 504 of FIG. 5) that is not an AP. The first wireless communication device may be paired with (e.g., tethered to) a second wireless communication device (e.g., second device 506 of FIG. 5) that is also not an AP. The first wireless communication device and the second wireless communication device may be associated with a wireless communication node (e.g., wireless communication node 502 of FIG. 5).

At step 1202, the first wireless communication device may generate a first frame to initiate TXOP sharing. For example, the first wireless communication device may transmit the first frame to the wireless communication node to indicate that the first wireless communication device is to share a transmission opportunity (TXOP) with the wireless communication node. In an example, the wireless communication node may use a remaining portion of the TXOP to transmit DL data based on receiving the frame. In some examples, the TXOP may be used to deliver traffic to the first wireless communication device. In other examples the TXOP may be used to deliver traffic to the second wireless communication device. In an example, the first frame may include an indication of whether the remaining portion of the TXOP should be used to transmit downlink data from the wireless communication node to either the first wireless communication device or the second wireless communication device.

In some embodiments, the first frame may include values that provide instructions related to the TXOP sharing. In an example, the first frame may include a first field (e.g., TXOP sharing enabled field 720 of FIG. 7). The first field may be set to a value indicating that the first wireless communication device is to share the TXOP with the wireless communication node to deliver traffic to the first wireless communication device or the second wireless communication device. For example, the first field may include a value of 1 to indicate that the wireless communication node receiving the first frame is to use the remaining portion of the TXOP to transmit DL data. In some examples, the first frame may include at least one of an association ID field (e.g., AID field 710 of FIG. 7), an address field (e.g., MAC address field 712 of FIG. 7), and quality of service (QOS) information element (IE) (e.g., QOS IE field 714 of FIG. 7). In some examples, the association ID field may be set to an association ID of a paired device. For example, the association ID field may be set to an association ID of the second wireless device. Likewise, the address field may be set to an address (e.g., MAC address and/or the like) of a peer device. in some examples, the QOS IE may be a set of QS parameters of a traffic stream between the wireless communication node and the second wireless communication device.

In some embodiments, the first frame may be an action frame. In these embodiments, the action frame may include a category field and an action details field. In an example, the category field may identify the action frame as an indication of a paired STA. For example, the category field may indicate that the first wireless communication device and the second wireless communication device are paired. In some examples, the action frame may include information about the paired device and how the TXOP sharing should be configured. The information may be included in the action details field. In some examples, the action frame may include a first field (e.g., TXOP sharing enabled field 720 of FIG. 7) set to a value indicating that the first wireless communication device is to share the TXOP with the wireless communication node to deliver traffic to the first wireless communication device or the second wireless communication device. In some examples, the action frame may include a second field (e.g., QoS config enabled field 722 of FIG. 7) set to a value indicating whether the first wireless communication device allows QoS configuration of the second wireless communication device. For example, the second field may be set to a value of 1 to indicate that the first wireless communication device allows QoS configuration of the second wireless communication device. In some examples, the action frame may include at least one of an association ID field (e.g., AID field 710 of FIG. 7) and an address field (e.g., MAC address field 712 of FIG. 7). The association ID field may be set to an association ID of the second wireless communication device. Likewise, the address field may be set to an address of the second wireless communication device.

In some embodiments, the first frame may include information about capabilities for TXOP sharing. The first frame may include a capabilities information element (IE) (e.g., UHR MAC capabilities information field 808 and/or UHR PHY capabilities information field 810 of FIG. 8). In some examples, the capabilities element may include a first field (e.g., STA initiated TXOP sharing support subfield 812 of FIG. 8) set to a value indicating that the first wireless communication device is to share the TXOP with the wireless communication node to deliver traffic to the first wireless communication device or the second wireless communication device. For example, the first field may be set to a value of 1 to indicate that the first wireless communication device supports STA initiated TXOP sharing. In some examples, the capabilities IE may include a second field (e.g., QOS IE for paired STA support subfield 814 of FIG. 8) set to a value indicating whether a QoS information element (IE) is supported. For example, the second field may be set to a value of 1 to indicate that the first wireless communication device may deliver QOS IE for traffic from the wireless communication node to the second wireless communication device.

In some embodiments, the first frame may include a control field. For example, the first frame may include an A-control subfield (e.g., A-control subfield 900 of FIG. 9). The control field may be associated with a control ID (e.g., control ID 906 of FIG. 9) indicating that the first wireless communication device is to share the TXOP with the wireless communication node to deliver traffic to the first wireless communication device or the second wireless communication device. As an example, the control ID may be set to a value that identifies the control field as initiating TXOP sharing. In some examples, the control field may include a duration field (e.g., duration field 910 of FIG. 9) set to a value indicating a remaining duration of the TXOP shared with the wireless communication node. In an example, the duration field may give a value representing the milliseconds left of the TXOP. In some examples, the control field may include a first field (e.g., DL field 914 of FIG. 9) set to a value indicating whether the wireless communication node uses the shared TXOP to serve downlink data to the first wireless communication device. For example, a value of 1 may indicate that the wireless communication is to use the shared TXOP to serve downlink data to the first wireless communication device. In some examples, the control field may include a second field (e.g., paired STA field 912 of FIG. 9) set to a value indicating whether the wireless communication node uses the shared TXOP to serve downlink data to the second wireless communication device. For example, a value of 1 may indicate that the wireless communication is to use the shared TXOP to serve downlink data to the second wireless communication device. In an example wherein both the first field and the second field are assigned a value of true (e.g., a value of 1), the wireless communication node may transmit downlink data to both the first wireless communication device and the second wireless communication device. In this example, the wireless communication node may use multi-user technologies to transmit data to both devices.

In some embodiments, the first frame may be a control frame. In some examples, the control frame may include a subtype field (e.g. subtype subfield 1020 of FIG. 10) set to a value indicating that the first wireless communication device is to share the TXOP with the wireless communication node to deliver traffic to the first wireless communication device or the second wireless communication device. In some examples, the subtype subfield 1020 may be assigned to a next available value to uniquely identify the frame as an STA initiated TXOP sharing frame. In some examples, the control frame may include a first field (e.g., DL field 1012 of FIG. 10) set to a value indicating whether the wireless communication node uses the shared TXOP to serve downlink data to the first wireless communication device. For example, a value of 1 in the first field may indicate that the wireless communication node may use the shared TXOP to serve downlink data to the first wireless communication device. In some examples, the control frame may include a second field (e.g., paired STA field 1010 of FIG. 10) set to a value indicating whether the wireless communication node uses the shared TXOP to serve downlink data to the second wireless communication device. For example, a value of 1 in the second field may indicate that the wireless communication node may use the shared TXOP to serve downlink data to the second wireless communication device.

In some embodiments, the first frame may be a trigger frame. As an example, the first frame may be a trigger frame including the user info field 1100 of FIG. 11. The trigger frame may include a TXOP sharing mode field set to a value indicating that the first wireless communication device is to share the TXOP with the wireless communication node to deliver traffic to the first wireless communication device or the second wireless communication device. As an example, the TXOP sharing mode field may be set to the value 3, as shown in table 1. In some examples, the trigger frame may include an association ID field (e.g., AID12 field 1102 of FIG. 11) set to an association ID of the second wireless communication device. In some embodiments, the trigger frame may be a multiuser (MU) request-to-send (RTS) TXOP sharing (TXS) trigger frame. In this example, the trigger frame may be used to coordinate uplink transmissions for the first wireless communication device and the second wireless communication device.

In some embodiments, the first frame may be part of a request to join a network. For example, the first frame may be one of an association response, a reassociation response, a probe response, or an action frame. These frames may be identified based on a subtype value (e.g., subtype subfield 1020 of FIG. 10) included in a management frame. As part of connecting to the network, the first wireless communication node may transmit information that initiates TXOP sharing.

At step 1204, the first wireless communication device may transmit the generated first frame to the wireless communication node. The wireless communication node may be in a wireless local area network (WLAN) that the first wireless communication device is connected to. In some examples, the first wireless communication device may allocate a remaining portion of a TXOP that the first wireless communication device has obtained to the wireless communication node based on transmitting the generated first frame. The wireless communication node may utilize the remaining portion of the TXOP to transmit downlink data to the first wireless communication device and/or the second wireless communication device based on receiving the generated first frame. In some examples, the generated first frame may indicate a the second wireless communication device to be a paired device. In this example, the wireless communication node may allocate the remaining TXOP based on instructions for allocating the TXOP for downlink data from the wireless communication node to the first and second wireless communication devices included in the generated first frame.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first wireless communication device comprising:
one or more processors configured to:
generate a first frame indicating to a wireless communication node that the first wireless communication device is to share a transmission opportunity (TXOP) with the wireless communication node to deliver traffic to the first wireless communication device or a second wireless communication device, wherein each of the first wireless communication device and the second wireless communication device is not a wireless communication node; and
wirelessly transmit, via a transmitter, the generated first frame to the wireless communication node in a wireless local area network (WLAN).

2. The first wireless communication device of claim 1, wherein:
the first wireless communication device and the second wireless communication device are associated with the wireless communication node, and
the first wireless communication device is paired or tethered to the second wireless communication device.

3. The first wireless communication device according to claim 1, wherein the first frame comprises:
a first field set to a value indicating that the first wireless communication device is to share the TXOP with the wireless communication node to deliver traffic to the first wireless communication device or the second wireless communication device; and
at least one of an association ID field, an address field, or quality of service (QOS) information element (IE), the association ID field set to an association ID of the second wireless communication device, the address field set to an address of the second wireless communication device, the QoS IE set to a set of QoS parameters of a traffic stream between the wireless communication node and the second wireless communication device.

4. The first wireless communication device according to claim 1, wherein the first frame is one of an association response, a reassociation response, a probe response, or an action frame.

5. The first wireless communication device according to claim 1, wherein:
the first frame is an action frame including a category field set to a value indicating that the first wireless communication device and the second wireless communication device are paired, and
the action frame comprises:
a first field set to a value indicating that the first wireless communication device is to share the TXOP with the wireless communication node to deliver traffic to the first wireless communication device or the second wireless communication device;
a second field set to a value indicating whether the first wireless communication device allows QoS configuration of the second wireless communication device, and
at least one of an association ID field or an address field, the association ID field set to an association ID of the second wireless communication device, the address field set to an address of the second wireless communication device.

6. The first wireless communication device according to claim 1, wherein:
the first frame comprises a capabilities information element (IE) relating to capabilities of the first wireless communication device, and
the capabilities IE comprises:
a first field set to a value indicating that the first wireless communication device is to share the TXOP with the wireless communication node to deliver traffic to the first wireless communication device or the second wireless communication device; and
a second field set to a value indicating whether a QoS information element (IE) is supported.

7. The first wireless communication device according to claim 1, wherein:
the first frame comprises a control field associated with a control ID indicating that the first wireless communication device is to share the TXOP with the wireless communication node to deliver traffic to the first wireless communication device or the second wireless communication device, and
the control field comprises:
a duration field set to a value indicating a remaining duration of the TXOP shared with the wireless communication node;
a first field set to a value indicating whether the wireless communication node uses the shared TXOP to serve downlink data to the first wireless communication device; and
a second field set to a value indicating whether the wireless communication node uses the shared TXOP to serve downlink data to the second wireless communication device.

8. The first wireless communication device according to claim 1, wherein:
the first frame is a control frame, and
the control frame comprises:
a subtype field set to a value indicating that the first wireless communication device is to share the TXOP with the wireless communication node to deliver traffic to the first wireless communication device or the second wireless communication device;
a duration field set to a value indicating a remaining duration of the TXOP shared with the wireless communication node;
a first field set to a value indicating whether the wireless communication node uses the shared TXOP to serve downlink data to the first wireless communication device; and
a second field set to a value indicating whether the wireless communication node uses the shared TXOP to serve downlink data to the second wireless communication device.

9. The first wireless communication device according to claim 1, wherein:
the first frame is a trigger frame, and
the trigger frame comprises:
a triggered TXOP sharing mode field set to a value indicating that the first wireless communication device is to share the TXOP with the wireless communication node to deliver traffic to the first wireless communication device or the second wireless communication device; and
an association ID field set to an association ID of the second wireless communication device.

10. The first wireless communication device according to claim 9, wherein:
the trigger frame is a multiuser (MU) request-to-send (RTS) TXOP sharing (TXS) trigger frame.

11. A method, comprising:
generating, by one or more processors of a first wireless communication device, a first frame indicating to a wireless communication node that the first wireless communication device is to share a transmission opportunity (TXOP) with the wireless communication node to deliver traffic to the first wireless communication device or a second wireless communication device, wherein each of the first wireless communication device and the second wireless communication device is not a wireless communication node; and
wirelessly transmitting, by the one or more processors via a transmitter, the generated first frame to the wireless communication node in a wireless local area network (WLAN).

12. The method of claim 11, wherein:
the first wireless communication device and the second wireless communication device are associated with the wireless communication node, and
the first wireless communication device is paired or tethered to the second wireless communication device.

13. The method according to claim 11, wherein
generating the first frame comprises:
setting a first field of the first frame to a value indicating that the first wireless communication device is to share the TXOP with the wireless communication node to deliver traffic to the first wireless communication device or the second wireless communication device,
the first frame comprises at least one of an association ID field, an address field, or quality of service (QOS) information element (IE), and
generating the first frame further comprises:
setting the association ID field to an association ID of the second wireless communication device,
setting the address field to an address of the second wireless communication device, or
setting the QoS IE to a set of QoS parameters of a traffic stream between the wireless communication node and the second wireless communication device.

14. The method according to claim 11, wherein the first frame is one of an association response, a reassociation response, a probe response, or an action frame.

15. The method according to claim 11, wherein:
the first frame is an action frame including a category field set to a value indicating that the first wireless communication device and the second wireless communication device are paired,
the action frame comprises a first field, a second field, and at least one of an association ID field or an address field, and
generating the first frame comprises:
setting the first field of the action frame to a value indicating that the first wireless communication device is to share the TXOP with the wireless communication node to deliver traffic to the first wireless communication device or the second wireless communication device;
setting the second field of the action frame to a value indicating whether the first wireless communication device allows QoS configuration of the second wireless communication device, and
setting the association ID field of the action frame to an association ID of the second wireless communication device, or setting the address field of the action frame to an address of the second wireless communication device.

16. The method according to claim 11, wherein:
the first frame comprises a capabilities information element (IE) relating to capabilities of the first wireless communication device, and
generating the first frame comprises:
setting a first field of the capabilities IE to a value indicating that the first wireless communication device is to share the TXOP with the wireless communication node to deliver traffic to the first wireless communication device or the second wireless communication device; and
setting a second field of the capabilities IE to a value indicating whether a QoS information element (IE) is supported.

17. The method according to claim 11, wherein:
the first frame comprises a control field associated with a control ID indicating that the first wireless communication device is to share the TXOP with the wireless communication node to deliver traffic to the first wireless communication device or the second wireless communication device, and
generating the first frame comprises:
setting a duration field of the control field to a value indicating a remaining duration of the TXOP shared with the wireless communication node;
setting a first field of the control field to a value indicating whether the wireless communication node uses the shared TXOP to serve downlink data to the first wireless communication device; and
setting a second field of the control field to a value indicating whether the wireless communication node uses the shared TXOP to serve downlink data to the second wireless communication device.

18. The method according to claim 11, wherein:
the first frame is a control frame, and
generating the first frame comprises:
setting a subtype field of the control frame to a value indicating that the first wireless communication device is to share the TXOP with the wireless communication node to deliver traffic to the first wireless communication device or the second wireless communication device;
setting a duration field of the control frame to a value indicating a remaining duration of the TXOP shared with the wireless communication node;
setting a first field of the control frame to a value indicating whether the wireless communication node uses the shared TXOP to serve downlink data to the first wireless communication device; and
setting a second field of the control frame to a value indicating whether the wireless communication node uses the shared TXOP to serve downlink data to the second wireless communication device.

19. The method according to claim 11, wherein:
the first frame is a trigger frame, and
generating the first frame comprises:
setting a triggered TXOP sharing mode field of the trigger frame to a value indicating that the first wireless communication device is to share the TXOP with the wireless communication node to deliver traffic to the first wireless communication device or the second wireless communication device; and
setting an association ID field of the trigger frame to an association ID of the second wireless communication device.

20. The method according to claim 19, wherein:
the trigger frame is a multiuser (MU) request-to-send (RTS) TXOP sharing (TXS) trigger frame.
